(19) United States
(12) Patent Application Publication
(10) Pub. No.: US 2026/0117583 A1
(43) Pub. Date: Apr. 30, 2026

(54) REUSEABLE INSPECTION HOLE COVER FOR BRICK AND BLOCK WALL CONSTRUCTION

(71) Applicant: GROUT STOPPERS LIMITED, Auckland (NZ)

(72) Inventors: Benjamin CARMODY, Auckland (NZ); Michael LIPANOVICH, Auckland (NZ)

(73) Assignee: GROUT STOPPERS LIMITED, Auckland (NZ)

(21) Appl. No.: 19/429,591

(22) Filed: Dec. 22, 2025

Related U.S. Application Data
(63) Continuation-in-part of application No. PCT/NZ2024/050074, filed on Jun. 20, 2024.

(30) Foreign Application Priority Data
Jun. 22, 2023 (NZ) 801198

(51) Int. Cl. E06B 5/00

(52) U.S. Cl. CPC E06B 5/00

(57) ABSTRACT

A cover apparatus designed for use in the construction of a block wall is disclosed. The apparatus includes a substantially flat front side intended to be positioned adjacent to the block wall, and a reinforced rear side featuring one or more ribs that provide structural support to the front side. The cover is also equipped with one or more apertures that extend from the front side to the rear side. Each aperture is designed to allow a tether to pass through, facilitating the secure attachment of the cover to the block wall. This configuration enhances the stability and integrity of the block wall during construction.

### FIELD OF THE INVENTION

The invention generally relates to an inspection cover for use with the construction of brick and block walls.

### BACKGROUND

A method of covering inspection holes in block walls is to use a section of timber to cover one or more holes. For example, a 300 mm High×25 mm Thick×length (varies) boxing timber. This boxing timber then needs to be predrilled in place through the timber then into the block work, once this is done a 65 mm×6 mm masonry screw is drilled into the predrilled hole to secure boxing timber to the block work. FIG. 1 shows a photo of an exemplary prior art implementation where a number of inspection holes 100 have been created at the base of a block wall, and makeshift timber covers 105 are arranged to cover the holes.

Another method is nailing boxing to block work with masonry nails. However, this is time consuming and labour intensive, requires the expense of nails, and removal of the nails from the blocks can cause damage.

Another method is placing blocks or other heavy material against boxing to hold in place. However, there is a high risk of concrete pushing the boxing away from the wall causing spillage extensive time and resources to clean up.

Each of the above methods also require a reasonable amount of space behind or in front of a wall to perform these duties. For example, there must be room to work with a drill, drill bit and masonry screw to be drilled into the boxing.

The object of the invention to go at least some way toward improving upon the methods and devices of the prior art, or which at least provides the public with a useful choice.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY OF THE INVENTION

In one aspect the invention relates to a cover apparatus adapted for use in the construction of a block wall, the cover apparatus comprising: a substantially flat front side adapted to be positioned adjacent to an inspection opening in the block wall; a rear side comprising one or more ribs adapted to provide support the front surface; one or more apertures formed through the cover from the front side to the rear side, each aperture allowing a tether to pass through for securing the cover to the block wall and over the inspection opening.

In one embodiment, the one or more ribs arranged to radiate from a central region of the rear side to an outer region.

In one embodiment, the ribs comprise an embossed formation extending outwardly from the rear side.

In one embodiment, the ribs comprise a pair of ribs arranged in an X-pattern, whereby the ribs cross in a central region of the rear side.

In one embodiment, the ribs further comprise a vertically aligned rib extending across the rear side and through the central region thereof.

In one embodiment, two or more ribs intersect in the central region of the rear side, and there are apertures horizontally located on either side of the intersection.

In one embodiment, the apparatus further comprises a block formation located centrally on the rear side of the cover, and two apertures extend through the block formation.

In one embodiment, the block formation further comprises outwardly extending contour located between the two apertures.

In one embodiment, the supporting ribs are arranged to radiate from the block formation.

In one embodiment, the ribs comprise a tapered cross section, thinnest at their most outward extent. In one embodiment, the one or more ribs comprise a rib extending about and encircling the outer periphery of the rear surface, the encircling rib merging with one or more other ribs spanning the rear surface of the cover.

In one embodiment, the apparatus is adapted to engage with a tether, the tether configured to tie the apparatus to one or more features of an inspection hole to be covered.

In one embodiment, the block wall comprises steel framework, and the tether is adapted to loop around the steel framework and pass through the apertures to be fastened adjacent the rear side of the cover.

In one embodiment, the front side comprises a textured surface.

In one embodiment, the apparatus is of a moulded plastic form.

In one aspect the invention relates to a cover apparatus adapted for use in the construction of a block wall, the cover comprising: a substantially flat front surface; a rear surface comprising one or more supporting ribs and a centrally located block formation; at least two apertures extending through the block formation from the front surface to the rear surface.

In some embodiments, the apparatus further comprises an outwardly extending contour located between at least two apertures.

In some embodiments, the apertures comprise a profile substantially complementary to a tether configured to pass through the apertures.

In some embodiments, the apparatus is of a moulded plastic form.

In some embodiments, the supporting ribs are arranged to substantially resist bending of the cover.

In some embodiments, the supporting ribs are arranged to extend from the block formation.

In some embodiments, the supporting ribs comprise a rib extending substantially about the periphery of the cover.

In some embodiments, the supporting ribs extend from the block formation to the outer edge of the cover.

In some embodiments, the apparatus is adapted to engage with a tether, the tether configured to tie the apparatus to one or more features of an inspection hole to be covered.

In some embodiments, the tether comprises a cable-tie.

In some embodiments, the cable tie is: 12 mm wide, 600 mm long.

In another broad aspect the invention relates to cover apparatus adapted for use in the construction of a block wall, the cover comprising: a substantially flat front side adapted to be positioned adjacent to the block wall; a rear side comprising one or more ribs adapted to provide support the front surface; one or more apertures formed through the cover from the front side to the rear side, each aperture allowing a tether to pass through for securing the cover to the block wall.

In some embodiments, the one or more ribs arranged to radiate from a central region of the rear side to an outer region.

In some embodiments, the apparatus further comprises a block formation located centrally on the rear side of the cover, and two apertures extend through the block formation.

In some embodiments, the block formation further comprises outwardly extending contour located between the two apertures.

In some embodiments, the one or more ribs comprise a rib extending about the outer periphery of the rear surface.

In some embodiments, the apparatus is adapted to engage with a tether, the tether configured to tie the apparatus to one or more features of an inspection hole to be covered.

In some embodiments, the front side comprises a textured surface.

In another broad aspect the invention relates to a method of constructing a block wall comprising:
creating an inspection hole in the base of the block wall;
attaching the cover apparatus of any one of the above embodiments, to the wall with a tether; and
pouring concrete into the interior of the block wall such that concrete flows through the inspection hole to abut against the cover.

In another broad aspect the invention relates to a kit of parts comprising a cover apparatus adapted for use in the construction of a block wall, the cover comprising: a substantially flat front surface;
a rear surface comprising one or more supporting ribs and a centrally located block formation; at least two apertures extending through the block formation from the front surface to the rear surface; and a tether configured to tie the apparatus to one or more features of an inspection hole to be covered.

The following embodiments may relate to any of the above aspects.

In one aspect the invention related to a method of constructing a block wall comprising creating an inspection opening in the base of the block wall; attaching the cover apparatus of any of the above aspect to the wall using a tether by passing the tether through the one or more apertures and securing the tether to an internal feature of the block wall; and pouring concrete into the interior of the block wall such that concrete flows through the inspection hole and contacts the cover.

In one embodiment the method further comprises looped the tether around the steel framework and fastening the tether on the rear side of the cover.

In another broad aspect the invention relates to a cover apparatus for use in the construction of a block wall, the cover apparatus comprising: a substantially flat front side adapted to be positioned adjacent to an inspection opening in the block wall; a rear side having a reinforcing structure comprising one or more ribs adapted to provide support to the front surface against pressure applied thereto; and one or more apertures formed through the cover from the front side to the rear side, each aperture configured to allow a flexible tether to pass therethrough for securing the cover to the block wall, wherein at least one of the one or more apertures is offset from a central region of the rear side.

In some embodiments, the one or more ribs are arranged to radiate from a central region of the rear side to an outer region.

In some embodiments, the one or more ribs comprise a pair of ribs arranged in an X-pattern, whereby the ribs cross in the central region of the rear side.

In some embodiments, the one or more apertures comprise at least one pair of apertures.

In some embodiments, the at least one pair of apertures is a first pair of apertures, and wherein the apparatus further comprises a second pair of apertures, the second pair also being offset from the central region of the rear side.

In some embodiments, the reinforcing structure comprises a vertically aligned central rib, and wherein the first pair of apertures is located on one side of the central rib and the second pair of apertures is located on an opposite side of the central rib.

In some embodiments, the one or more ribs comprise a peripheral rib extending about and encircling an outer periphery of the rear side, the peripheral rib merging with at least one of the other ribs.

In some embodiments, the front side comprises a textured surface.

In some embodiments, the flexible tether comprises a cable-tie.

In some embodiments, the apparatus is of a moulded plastic form.

In another broad aspect the invention relates to a method of constructing a block wall comprising:
creating an inspection opening in a base of the block wall;
providing the cover apparatus of any of the above aspects; attaching the cover apparatus to the wall by passing a flexible tether through at least one of the one or more apertures and securing the tether to an internal feature of the block wall; and pouring concrete into an interior of the block wall such that the concrete flows through the inspection opening and contacts the cover.

In some embodiments, the flexible tether comprises a cable-tie.

In another broad aspect the invention relates to a cover apparatus adapted for use in the construction of a block wall, the cover apparatus comprising: a substantially flat front side adapted to be positioned adjacent to an inspection opening in the block wall; a rear side comprising one or more ribs adapted to provide support to the front surface; and one or more apertures formed through the cover from the front side to the rear side, each aperture allowing a flexible tether to pass therethrough for securing the cover to the block wall over the inspection opening.

In some embodiments, the one or more ribs comprise a pair of ribs arranged in an X-pattern, whereby the ribs cross in a central region of the rear side.

In some embodiments, the one or more ribs comprise a peripheral rib extending about and encircling an outer periphery of the rear side, the peripheral rib merging with at least one of the other ribs.

In some embodiments, the apparatus further comprises a block formation located centrally on the rear side of the cover, and wherein two of the one or more apertures extend through the block formation.

In some embodiments, the flexible tether comprises a cable-tie.

In some embodiments, the front side comprises a textured surface.

In some embodiments, the apparatus is of a moulded plastic form.

In another broad aspect the invention relates to a method of constructing a block wall comprising:
creating an inspection opening in a base of the block wall;
providing the cover apparatus of any of the above aspects; attaching the cover apparatus to the wall by passing a flexible tether through the one or more apertures and securing the tether to an internal feature of the block wall; and pouring concrete into an interior of the block wall such that the concrete flows through the inspection opening and contacts the cover.

In another broad aspect the invention relates to a method of constructing a block wall comprising:
creating an inspection opening in a base of the block wall;
providing the cover apparatus of any of the above aspects; attaching the cover apparatus to the wall by passing a flexible tether through at least one of the one or more apertures and securing the tether to an internal feature of the block wall; and pouring concrete into an interior of the block wall such that the concrete flows through the inspection opening and contacts the cover.

In another broad aspect the invention relates to a method of constructing a block wall comprising:
creating an inspection opening in a base of the block wall; providing a cover apparatus comprising a substantially flat front side, a rear side with a reinforcing structure of one or more ribs, and at least one pair of apertures extending from the front side to the rear side, wherein the pair of apertures is offset from a central region of the cover apparatus; attaching the cover apparatus to the wall by passing a flexible tether through the at least one pair of apertures and securing the tether to an internal feature of the block wall; and pouring concrete into an interior of the block wall such that the concrete flows through the inspection opening and contacts the cover.

The present invention relates to a cover apparatus designed for use in the construction of a block wall, specifically for creating an inspection hole at the base of the wall, attaching the cover securely, and subsequently pouring concrete into the wall. This cover apparatus ensures that the concrete flows properly and abuts against the cover, providing structural integrity to the wall.

The cover apparatus of the present invention comprises a substantially flat front side and a rear side that features one or more ribs for structural support. The front side is adapted to be positioned adjacent to the block wall, providing a smooth interface for abutting against the wall. The rear side is designed to offer reinforcement to the flat front side through the inclusion of ribs. These ribs provide additional strength and support to the cover. Additionally, the cover includes one or more apertures that extend from the front side to the rear side, allowing a tether to pass through for securing the cover to the block wall.

In one embodiment of the invention, the ribs on the rear side are arranged to radiate from a central region towards the outer region. This radial arrangement of ribs ensures even distribution of support across the entire cover, enhancing its structural integrity.

Another embodiment of the invention features a block formation located centrally on the rear side of the cover. This block formation includes two apertures that extend through it, providing pathways for tethers to secure the cover more effectively to the block wall.

The block formation in this embodiment further comprises an outwardly extending contour located between the two apertures. This contour provides additional structural support and helps to guide the tethers through the apertures, ensuring they are securely positioned.

The supporting ribs in this configuration are arranged to extend from the block formation, further reinforcing the structure of the cover and providing additional support to the flat front side.

In another embodiment, the one or more ribs include a rib that extends around the outer periphery of the rear surface. This peripheral rib provides additional rigidity to the cover, ensuring it maintains its shape and structural integrity during the concrete pouring process.

The cover apparatus is designed to engage with a tether, which is configured to tie the apparatus to one or more features of the inspection hole to be covered. This ensures that the cover remains securely in place during the construction process.

In one variant, the front side of the cover apparatus comprises a textured surface. This textured surface can provide better adhesion to the block wall and enhance the stability of the cover when in use.

The tether used in conjunction with the cover apparatus can comprise a cable-tie. This type of tether is suitable for providing a secure and adjustable means of attachment.

Specifically, the cable-tie used as a tether can be 12 mm wide and 600 mm long. These dimensions ensure the cable-tie is strong enough to hold the cover in place and long enough to wrap around the necessary features of the block wall.

The cover apparatus is preferably of a moulded plastic form. This material choice provides durability, flexibility, and ease of manufacturing, making the cover both cost-effective and efficient for use in construction.

The invention also encompasses a method of constructing a block wall using the described cover apparatus. The method involves the following steps: Creating an inspection hole in the base of the block wall. Attaching the cover apparatus to the wall using a tether by passing the tether through the one or more apertures and securing the tether to an internal feature of the block wall.

Pouring concrete into the interior of the block wall such that the concrete flows through the inspection hole and contacts the cover. In this method, the tether used to secure the cover apparatus can comprise a cable-tie. This provides a simple yet effective means of attachment, ensuring the cover.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement or claim, all need to be present but other features can also be present. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1 shows a prior art method of covering an inspection hole using a timber plank.

FIG. 2 shows a perspective view of a reusable cover apparatus for use in covering an inspection hole in a block wall as concrete is poured into the block cells.

FIG. 3 shows a plan view of the rear side of the cover.

FIG. 4 shows an edge view of the cover.

FIG. 5 shows a cross sectional view of the cover.

FIG. 6 shows a perspective view of the front side of the cover.

FIG. 7 shows a perspective view of the front side of a second form.

FIG. 8 shows a plan view of the back side of the second form of the reusable cover apparatus.

FIG. 9 shows a plan view of the front side.

FIG. 10 shows a photo of the apparatus in use.

FIG. 11 shows an exemplary volume of concrete for a load calculation.

FIGS. 12(A) and 12(B) show a perspective and side view of applied force deformation of an exemplary cover.

FIG. 13 shows a front perspective view of another cover embodiment.

FIG. 14 shows a first rear perspective view of the other cover embodiment.

FIG. 15 shows a second rear perspective view of the other cover embodiment.

FIG. 16 shows a front view of the other cover embodiment.

FIG. 17 shows a rear view of the other cover embodiment.

FIG. 18 shows a right side view of the other cover embodiment.

FIG. 19 shows a left side view of the other cover embodiment.

FIG. 20 shows a top view of the other cover embodiment.

FIG. 21 shows a bottom view of the other cover embodiment.

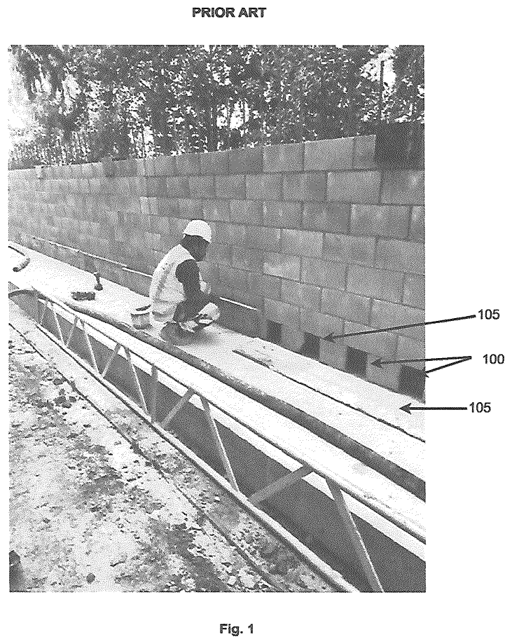

### DETAILED DESCRIPTION

The present invention finds application in the construction of a brick or block wall. Such walls are typically used as foundation or retaining walls and include steel reinforcement and the inclusion of concrete within the centre of the bricks or blocks.

One exemplary method of construction of such a wall involves several steps. A detailed explanation of the process is as follows:
1. Planning and Preparation:
   Determine the dimensions and location of the wall. Mark the boundaries using stakes and string lines.
   Obtain the necessary permits and permissions if required by local regulations.
   Calculate the number of blocks, steel reinforcement, and concrete mix required based on the wall's dimensions.
2. Excavation and Foundation:
   Excavate the area along the wall's path, ensuring a level and compacted base.
   Dig a trench for the foundation, typically below the frost line or as per local building codes.
   Install a layer of crushed stone or gravel in the trench for proper drainage.
   Compact the base and use a level to ensure it is even and stable.
3. Setting up the Rebar:
   Determine the required reinforcement for the wall based on engineering specifications and local codes.
   Cut and bend the steel reinforcement bars (rebar) as per the design requirements.
   Place the rebar horizontally and vertically within the hollow cores of the blocks, leaving enough clearance from the block edges to allow concrete flow.
   Use tie wire to secure the rebar intersections and ensure stability.
4. Laying the Blocks:
   Begin at a corner of the wall and apply a bed of mortar on the foundation.
   Place the first block in the mortar bed, pressing it firmly and ensuring it is level and plumb using a spirit level.
   Apply mortar on the top and end surfaces of the block and place the next block, maintaining the desired joint width.
   Repeat this process, periodically checking for levelness, plumbness, and alignment.
5. Creating Inspection Holes:
   Determine the locations where inspection holes will be installed. These are typically placed at intervals along the wall to check the depth of the poured concrete. The inspection holes are typically required so that an engineer can inspect the interior of the wall before concrete is poured to ensure the strength of the wall will meet desired specifications. Also, the inspection holes ensure that debris, such as mortar (having a lower strength than concrete) used in adhering the blocks to each other and the foundation, has not fallen into the interior of the wall. City council regulations may also require that an inspection takes place.
   Leave specific blocks out of the wall to create these holes, ensuring they are placed in appropriate locations and securely supported. Alternatively, inspection holes can be cut into the side of the blockwork.
   Install covers over the inspection holes to prevent concrete from spilling out and provide later access for concrete inspection.
6. Pouring Concrete:
   Once the block wall is complete, prepare the concrete mix according to the manufacturer's instructions. The mix should have a consistency suitable for pouring.
   Pour the concrete mix into the cells at the top of the wall. Fill each cell until the concrete reaches the top.
   Use a rod or vibrating tool to remove any air bubbles or voids and ensure proper consolidation of the concrete.
7. Finishing:
   Smooth the surface of the poured concrete to create a uniform appearance using a trowel or float.
   Allow the concrete to cure according to the recommended time frame provided by the concrete mix manufacturer.
   Remove the covers from the inspection holes and inspect the concrete to ensure it has reached the desired level and cured properly.

There is a need to ensure the concrete has filled all the cells in the block wall which occurs as described above in relation to part 5. The concrete fill can be visually inspected at the top of the wall. However, there is no way to visually inspect the bottom of the wall. To solve this issue, the inspection holes are provided in the side of the blocks at regular intervals. The inspection holes are covered while concrete is poured, then once the concrete is set, the hole is uncovered to ensure concrete has filled the region. In instances where concrete has not filled a lower region of the wall, concrete must be back filled into the void and the surface of the block wall finished as desired.

The present invention relates to an improved device for and method of covering the inspection hole in the block wall, and an apparatus for use with the method.

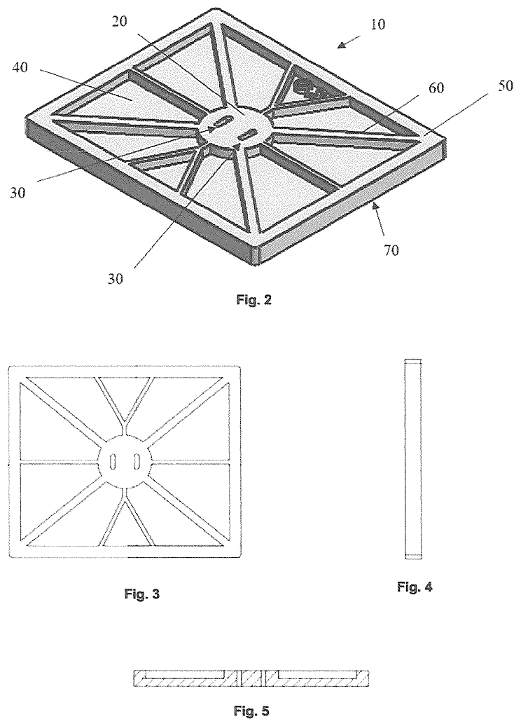

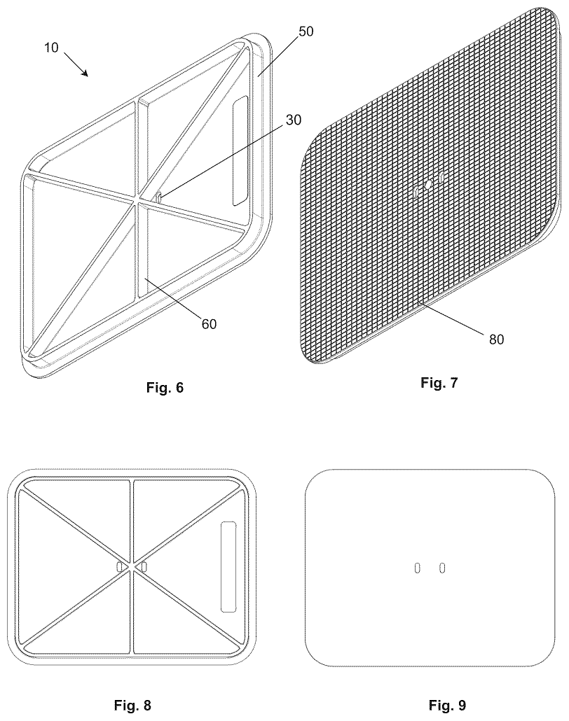

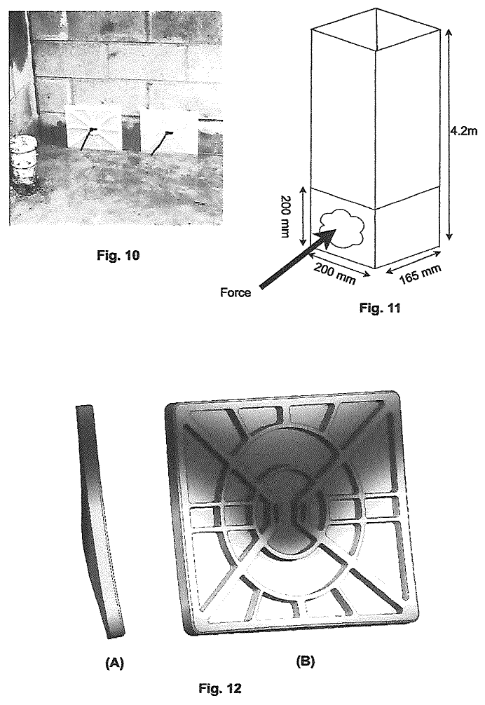

FIGS. 2-5 show a first form of a reusable cover apparatus or “cover”. FIGS. 6-10 show a second form of the reusable cover apparatus. In some forms, the cover is substantially rectangular. FIG. 2 shows a perspective view of a reusable cover apparatus 10 for use in covering an inspection hole in a block wall as concrete is poured into the block cells. FIG. 3 shows a plan view of the rear side of the cover; FIG. 4 shows an edge view of the cover; FIG. 5 shows a cross sectional view of the cover; and FIG. 6 shows a perspective view of the front side of the cover. FIGS. 2-4 include suggested operational dimensions of the cover apparatus according to one exemplary embodiment. FIG. 6 shows a perspective view of the back side of the second form of the reusable cover apparatus and FIG. 7 shows a perspective view of the front side. FIG. 8 shows a plan view of the back side of the second form of the reusable cover apparatus and FIG. 9 shows a plan view of the front side. FIG. 10 shows a photo of the apparatus in use.

In each form, the cover 10 comprises a substantially flat cover face 70 which is configured to face the exterior surface of a block wall and span at least the size of the inspection hole. The flat face 70 of the cover 10 ensures concrete flowing through the inspection hole is finished substantially flush with the exterior of the block wall surface to produce a substantially continuous surface.

On the back side of the cover 10, there is a substantially centrally located block formation 20 which extends from the rear surface 40 of the cover.

In some embodiments, the cover apparatus has a boarder formation 50 which extends substantially about the periphery of the cover. In some embodiments, the cover apparatus has a number of support ribs 60 which radiate from the central block formation 20 to the periphery of the cover. The ribs help to provide resistance against deformation of the cover while against a block wall and subjected to concrete loads against the front surface. Any arrangement of ribs is possible as may be desirable to achieve a desired bending resistance. Similarly, any formation of the boarder formation 50 is possible depending on the desired bending resistance.

In some embodiments, the ribs comprise an arrangement of embossed features which extend outward from the rearward surface of the cover. In some embodiments, the ribs comprise an arrangement of ribs which extend from a central region of the cover to the outer corners thereof to thereby form an X-pattern. In some embodiments, the arrangement of ribs comprises a rib which extends vertically and centrally to the cover, from a top edge to a bottom edge thereof when the cover is rectangular and viewed in a landscape form. This arrangement of ribs is shown in FIGS. 6 and 8.

Other ribs may optionally be arranged on the rear side of the cover. However, there is an advantage in minimalizing the materials required to produce a cover. As such, for most intended applications, the arrangement of ribs shown provides a balance between meeting the strength requirements and minimalization of materials.

The cover apparatus 10 has one or more apertures 30 which extend from the front side the back side. In some embodiments, there are two apertures which are positioned to extend through the centrally located block formation 20 such as shown in the first form of FIGS. 2 to 5. The apertures 30 extend from the front surface of the cover through to the rear surface. The apertures are configured to allow the pass-through of a tether. The tether is a releasably attachable mechanism which allows securing of the tether to the block wall during pouring of the concrete. In some embodiments, the tether is looped through the cover apertures, and also an interior feature of the block wall such as any wall reinforcement including rebar. In some embodiments, the tether is a cable-tie. However, wire, string or similar material may be used to secure the cover to the wall. In some embodiments, a tether is fastened inside the wall, passes through the cover, and is fastened on the rear side of the cover to hold the tether against the wall.

In some embodiments, the central block formation 20 has a contour which extends at least between the location of the apertures 30. In some embodiments, the contour is a convex form extending outwardly from the cover. A convex formation, for example, helps to distribute the force of a tether which is looped between the apertures.

In some embodiments, the apertures are of a shape which complements the profile of the tether the cover is intended to be used with. For example, in some embodiments, the intended tether is a cable-tie, and the apertures have a rectangular profile substantially complementary to the profile of the cable-tie. In this way, there are no or few gaps where concrete may leak through the apertures.

In some embodiments, the arrangement of ribs comprises a pattern which cross in the central region of the cover such that the central region of the cover comprises a raised formation formed from the merging of several ribs. In such embodiments, an aperture 30 is located on each side of the raised formation such that a tether passing through the apertures will be fastened over the top of the raised formation. In doing so, the tether will apply pressure to the central region of the cover to help stabilise and secure the cover against the load of the concrete inside inspection hole.

The tether being tightened over the top of the ribs provide a force which is distributed along the length of the ribs. This arrangement supports the front surface of the cover against the load applied by concrete in the inspection hole.

FIG. 11 shows an example of a substantially column which would typically represent a segment of block wall. In the example, the column is 4.2 m tall and has an interior dimension of 200 mm by 165 mm. An inspection hole is created in the lower 200 mm of the column. The volume of the concrete at the inspection hole opening is calculated as 0.2×0.2×0.165×4.2=0.0277 cubic metres. Based on the density of concrete, the approximate weight or applied to a cover held against the cover would be 0.0277×2500 kg/m³, which is about 70 kg of force.

FIG. 12 shows deformation of the cover under an extreme applied load to exemplify the deformation which may take place. FIG. 12(A) shows a side perspective view of an exemplary cover and FIG. 12(B) shows a rear perspective view of the exemplary cover.

In some embodiments, the cover 10 is constructed of a plastic material. Plastic is a preferred material as it is suitable for mass production with a moulding process. Further, plastic will not stick to concrete, allowing easy separation of the cover from the wall once the concrete has set. In some embodiments, the plastic is a recycled plastic material.

In some embodiments, the front side of the cover has a textured surface such as that shown in FIG. 7. The textured surface may be advantageous for cosmetic or structural purposes. One structural purpose is to provide texture for mechanically adhering with a finishing layer such a plaster which may be applied to the surface of the block wall. The textured surface also promotes friction with the block wall face to help stabilise the cover as the tether is applied.

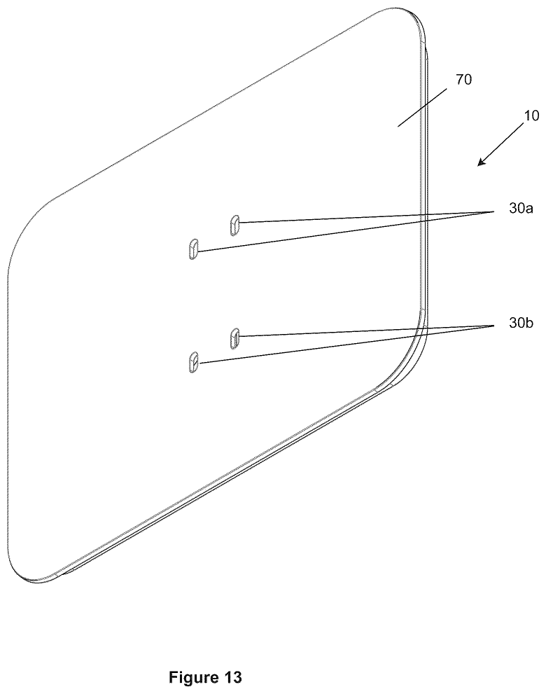

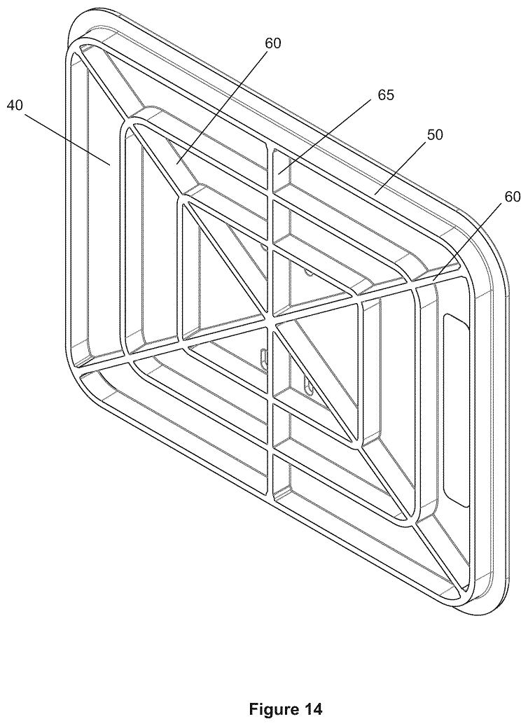

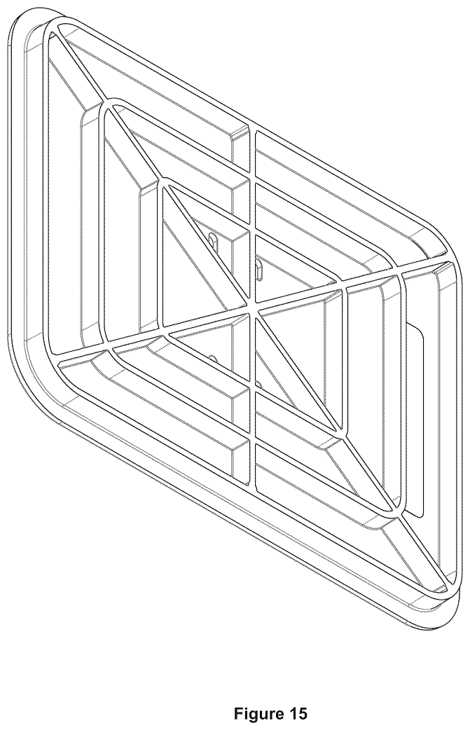

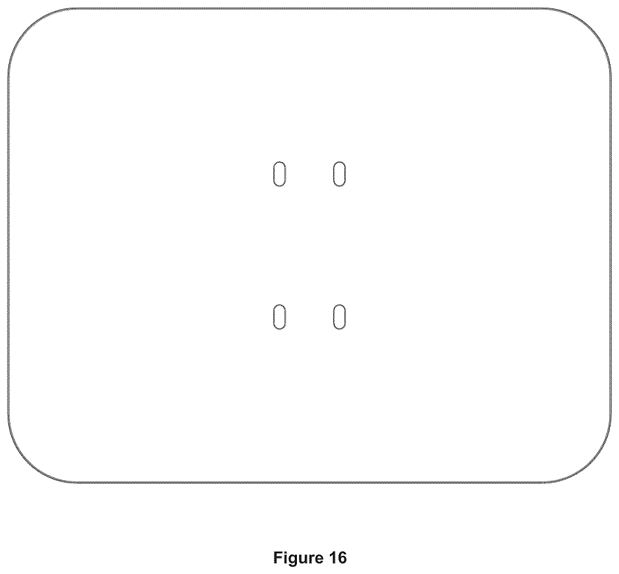

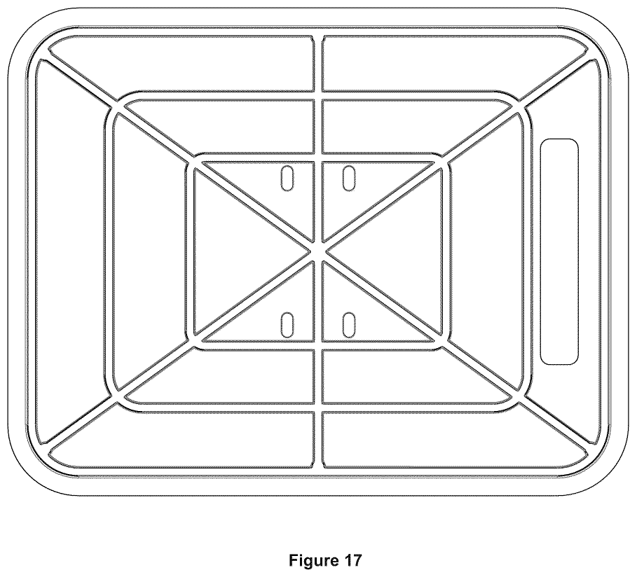

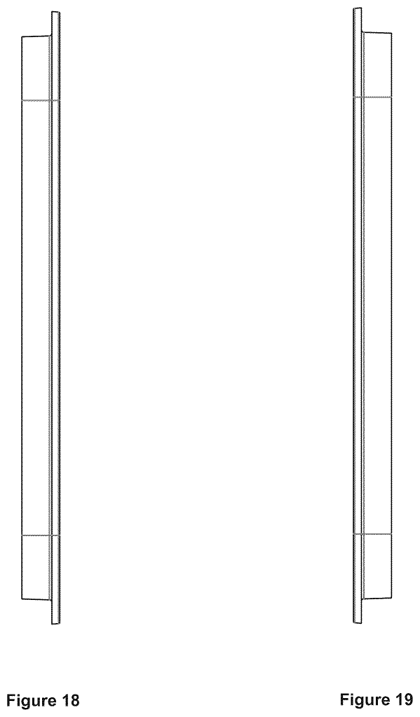

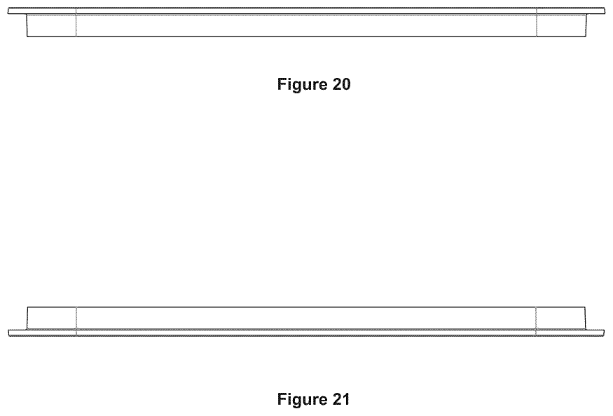

FIGS. 13-21 illustrate a further preferred embodiment of the reusable cover apparatus 10. This embodiment is specifically configured to provide an enhanced distribution of securing force against the hydrostatic pressure exerted by poured concrete. In particular, FIG. 13 shows a front perspective view, FIG. 14 shows a first rear perspective view, FIG. 15 shows a second rear perspective view, FIG. 16 shows a front view, FIG. 17 shows a rear view, FIG. 18 shows a right side view, FIG. 19 shows a left side view, FIG. 20 shows a top view, FIG. 21 shows a bottom view.

As shown in this embodiment, the rear side 40 of the cover apparatus 10 features a reinforcing structure that includes a prominent, centrally located, vertically aligned rib 65. This central vertical rib 65 extends substantially along the height of the cover apparatus 10 and works in concert with a plurality of supporting ribs 60, which may be arranged in an X-pattern, and a peripheral rib 50 to provide comprehensive structural rigidity.

The key improvement in this embodiment lies in the placement of the apertures. To more effectively counteract the bending forces from concrete pressure, which are highest away from the center, the apparatus comprises at least one pair of apertures that is offset from the central axis of the cover. By offsetting the apertures, the securing force applied by the flexible tether is concentrated closer to the regions of maximum load, thereby reducing the tendency of the cover's front face 70 to bow.

A particularly advantageous implementation, as depicted in the drawings, features two pairs of apertures: a first pair 30a and a second pair 30b. While only one offset pair is necessary to achieve the primary technical benefit, the inclusion of a second, symmetrically-placed pair provides significant advantages.

Firstly, the presence of two pairs of apertures makes the cover orientation-agnostic. The user does not need to ensure the cover is installed with a specific “top” or “bottom” orientation, which simplifies and accelerates the installation process on a construction site.

Secondly, it offers versatility in securing the cover. A user can employ a single flexible tether through one of the pairs (30a or 30b). Optionally, for applications requiring maximum holding force, a second tether can be used in the other pair of apertures, or a single long tether can be woven through all four apertures to provide two points of contact with the internal rebar. This adaptability ensures the cover is robustly secured across various conditions.

In another varied embodiment of the invention, the cover apparatus is configured for securing with a single-piece adjustable tether that passes through a single functional aperture. This configuration provides a simple and effective alternative fastening method.

In this embodiment, the cover apparatus retains its essential structural characteristics, including the substantially flat front side and the rear side featuring a robust reinforcing structure of one or more ribs. The primary modification relates to the apertures. The cover comprises at least one aperture that is intentionally offset from the central region of the cover. This offset placement is a key technical feature, as it allows the securing force from the tether to be applied closer to the areas of the covers front face that experiences the highest load from the poured concrete, thereby improving stability and minimising any potential for the cover to bow under pressure.

In a particularly preferred and user-friendly implementation, the cover apparatus comprises a second aperture, which is mirrored symmetrically on the opposite side of the central region. While only one of the offset apertures is used for fastening at any given time, the presence of two mirrored apertures makes the cover orientation-agnostic. This design significantly simplifies installation on a construction site, as the user does not need to ensure the cover is positioned with a specific “top” or “bottom” orientation before securing it.

This embodiment is designed to be used with a specialised single-piece adjustable tether. This tether is a self-contained fastening device comprising: an engagement end, such as a hook or clasp, designed to securely attach to an internal feature of the block wall like rebar; an elongated, flexible strap body that extends from the engagement end; and an integrated locking mechanism, such as a buckle-style fastener or locking head. This locking mechanism is configured to receive the strap body and includes an internal pawl or catch that engages with teeth or ridges on the strap, allowing the strap to be tightened but preventing it from loosening.

To use this embodiment, a user first attaches the engagement end of the tether to the rebar inside the inspection opening. The flexible strap body is then fed from inside the wall out through one of the selected offset apertures on the cover apparatus. With the cover held against the block wall, the free end of the strap body is passed into its corresponding locking mechanism and pulled taut. This action cinches the cover securely against the exterior of the block wall, with the offset force application providing excellent stability. The locking mechanism automatically maintains the tension, holding the cover firmly in place during the concrete pour.

A further benefit of the invention is the amount of space needed behind a wall in order to fix the cover to a wall is significantly reduced compared to methods of the prior art which require the use of a drill.

The method of use of the above-described cover embodiments is summarised as follows:
Once the block wall is complete, prepare inspection holes near the base of the wall.
Loop a tether between the cover 10 and an internal feature of the wall such as rebar. Tighten the tether such that the cover is firmly held to the exterior face of the wall.
Pour the concrete mix into the hollow cores of the blocks, starting from the lowest level and working upwards.
Continue pouring concrete until all cells are filled, making sure it is level with the top surface of the blocks.
Once the concrete has set, remove the tether and either:
   Cut tether ends protruding from the concrete, or
   Pull tether through the concrete to remove from the wall.
Reuse the cover 10 on the next block wall construction.

In some embodiments, there is a kit of parts containing an inspection cover as described above in relation to any embodiment, together with a tether, whereby the tether is a cable-tie or zip-tie. In some embodiments, the tether is 12 mm wide, 600 mm long. The tether is substantially rectangular in cross section and is substantially complimentary to the cross-sectional shape of the apertures passing through the centre of the cover.

In some embodiments, the cover is injection moulded from an ABS plastic polymer. Preferred dimensions will depend on the size of the inspection hole. However, cover dimensions of 330 mm wide, and 260 mm high have been found to perform well. Two apertures with a spacing of about 33 mm is adequate to provide tether leverage to the cover. A cover thickness of 4 to 5 mm provides adequate stiffness in combination with ribs which are about 4 mm thick and about 12 to 13 mm tall. In some forms, the ribs are tapered in height such that they are thicker where they meet the cover and thinner as they project outward.

Where in the foregoing description reference has been made to elements or integers having known equivalents, then such equivalents are included as if they were individually set forth. Although the invention has been described by way of example and with reference to particular embodiments, it is to be understood that modifications and/or improvements may be made without departing from the scope of the invention as set out in the claims.

1. A cover apparatus for use in the construction of a block wall, the cover apparatus comprising:
a substantially flat front side adapted to be positioned adjacent to an inspection opening in the block wall,
a rear side having a reinforcing structure comprising one or more ribs adapted to provide support to the front surface against pressure applied thereto, and
one or more apertures formed through the cover from the front side to the rear side, each aperture configured to allow a flexible tether to pass therethrough for securing the cover to the block wall,
wherein at least one of the one or more apertures is offset from a central region of the rear side.

2. The apparatus of claim 1, wherein the one or more ribs are arranged to radiate from a central region of the rear side to an outer region.

3. The apparatus of claim 1, wherein the one or more ribs comprise a pair of ribs arranged in an X-pattern, whereby the ribs cross in the central region of the rear side.

4. The apparatus of claim 1, wherein the one or more apertures comprise at least one pair of apertures.

5. The apparatus of claim 4, wherein the at least one pair of apertures is a first pair of apertures, and wherein the apparatus further comprises a second pair of apertures, the second pair also being offset from the central region of the rear side.

6. The apparatus of claim 5, wherein the reinforcing structure comprises a vertically aligned central rib, and wherein the first pair of apertures is located on one side of the central rib and the second pair of apertures is located on an opposite side of the central rib.

7. The apparatus of claim 1, wherein the one or more ribs comprise a peripheral rib extending about and encircling an outer periphery of the rear side, the peripheral rib merging with at least one of the other ribs.

8. The apparatus of claim 1, wherein the front side comprises a textured surface.

9. The apparatus of claim 1, wherein the flexible tether comprises a cable-tie.

10. The apparatus of claim 1, wherein the apparatus is of a moulded plastic form.

11. A method of constructing a block wall comprising:
creating an inspection opening in a base of the block wall;
providing a cover apparatus including;
a substantially flat front side adapted to be positioned adjacent to an inspection opening in the block wall,
a rear side having a reinforcing structure comprising one or more ribs adapted to provide support to the front surface against pressure applied thereto, and
one or more apertures formed through the cover from the front side to the rear side, each aperture configured to allow a flexible tether to pass therethrough for securing the cover to the block wall,
wherein at least one of the one or more apertures is offset from a central region of the rear side,
attaching the cover apparatus to the wall by passing a flexible tether through at least one of the one or more apertures and securing the tether to an internal feature of the block wall, and
pouring concrete into an interior of the block wall such that the concrete flows through the inspection opening and contacts the cover.

12. The method as claimed in claim 11, wherein the flexible tether comprises a cable-tie.

13. A cover apparatus adapted for use in the construction of a block wall, the cover apparatus comprising:
a substantially flat front side adapted to be positioned adjacent to an inspection opening in the block wall,
a rear side comprising one or more ribs adapted to provide support to the front surface, and
one or more apertures formed through the cover from the front side to the rear side, each aperture allowing a flexible tether to pass therethrough for securing the cover to the block wall over the inspection opening.

14. The apparatus of claim 13, wherein the one or more ribs comprise a pair of ribs arranged in an X-pattern, whereby the ribs cross in a central region of the rear side.

15. The apparatus of claim 13, wherein the one or more ribs comprise a peripheral rib extending about and encircling an outer periphery of the rear side, the peripheral rib merging with at least one of the other ribs.

16. The apparatus of claim 13, wherein the apparatus further comprises a block formation located centrally on the rear side of the cover, and wherein two of the one or more apertures extend through the block formation.

17. The apparatus of claim 13, wherein the flexible tether comprises a cable-tie.

18. The apparatus of claim 13, wherein the front side comprises a textured surface.

19. The apparatus of claim 13, wherein the apparatus is of a moulded plastic form.

20. A method of constructing a block wall comprising:
creating an inspection opening in a base of the block wall;
providing a cover apparatus including;
a substantially flat front side adapted to be positioned adjacent to an inspection opening in the block wall,
a rear side comprising one or more ribs adapted to provide support to the front surface, and
one or more apertures formed through the cover from the front side to the rear side, each aperture allowing a flexible tether to pass therethrough for securing the cover to the block wall over the inspection opening,
attaching the cover apparatus to the wall by passing a flexible tether through the one or more apertures and securing the tether to an internal feature of the block wall; and
pouring concrete into an interior of the block wall such that the concrete flows through the inspection opening and contacts the cover.
